(19) United States
(12) Patent Application Publication
(10) Pub. No.: US 2010/0083583 A1
(43) Pub. Date: Apr. 8, 2010

(54) CUTTING TOOL

(76) Inventors: Hitoshi Sumiya, Hyogo (JP); Kazushi Obata, Tokyo (JP); Miki Yoshinaga, Hyogo (JP)

Correspondence Address: BIRCH STEWART KOLASCH & BIRCH, PO BOX 747, FALLS CHURCH, VA, 22040-0747, US

(21) Appl. No.: 12/523,543

(22) PCT Filed: Jan. 18, 2008
(86) PCT No.: PCT/JP2008/050573

§ 371 Date: Jul. 17, 2009

(30) Foreign Application Priority Data
Jan. 19, 2007 (JP) 2007-010100

(51) Int. Cl. B23B 27/20; B23B 27/14; C01B 31/06

(52) U.S. Cl. 51/307

(57) ABSTRACT

One object of the present invention is to provide a cutting tool excellent in strength and wear resistance. The cutting tool has a cutting blade formed using a highly hard diamond polycrystalline body made substantially only of diamond and produced by directly converting a raw material composition including a non-diamond type carbon material into diamond and sintering the diamond at an ultra high pressure and an ultra high temperature without adding a sintering aid or a catalyst, the polycrystalline body having a mixed construction including fine-grained diamond crystals with a maximum grain size of less than or equal to 100 nm and an average grain size of less than or equal to 50 nm and plate-like or particulate coarse-grained diamond crystals with a minimum grain size of greater than or equal to 50 nm and a maximum grain size of less than or equal to 10000 nm.

### TECHNICAL FIELD

The present invention relates to a cutting tool for precision machining, and in particular relates to a cutting tool for precision machining for precisely machining an aluminum alloy, a copper alloy, electroless nickel plating, resin, hard and brittle materials and difficult-to-machine materials such as glass, carbon, MMCs, and the like.

### BACKGROUND ART

Conventionally, natural monocrystalline diamond or synthetic monocrystalline diamond has been used in cutting tools for precision machining of various materials. However, there has been a problem that, when monocrystalline diamond is used in a cutting tool, a blade edge is chipped or a blade edge portion is unevenly worn during use, and thus the cutting tool cannot provide precision machining. In diamond monocrystal, distances between crystal lattice planes differ depending on orientation, and the lattice planes have different in-plane atomic densities. Therefore, diamond monocrystal has a cleavage property, and has hardness and wear resistance that are significantly direction-dependent, causing a defect as described above.

At present, all polycrystalline diamonds marketed for use in tools use an iron group metal such as Co, Ni, Fe, or a ceramic such as SiC, as a sintering aid or a binding agent. They are obtained by sintering diamond powder together with a sintering aid or a binding agent under high-pressure and high-temperature conditions in which diamond is thermodynamically stable (generally, at a pressure of 5 to 6 GPa and at a temperature of 1300 to 1500° C.). However, since they contain around 10% by volume of a sintering aid or a binding agent, it is not possible to obtain highly precise blade edge and working surface, and thus such a polycrystalline diamond is not applicable to a precision machining tool. Although naturally produced polycrystalline diamonds (carbonado and ballas) are also known, and some of them are used as a drill bit, they have many defects and they considerably vary in material quality. Therefore, they are not used for the applications described above.

On the other hand, a polycrystalline body of single phase diamond having no binding agent is obtained by directly converting non-diamond carbon such as graphite, glassy carbon, amorphous carbon, or the like into diamond and simultaneously sintering the diamond at an ultra high pressure and an ultra high temperature without a catalyst or a solvent.

As such a polycrystalline body, for example, J. Chem. Phys., 38 (1963) 631-643 [F. P. Bundy] (Non-Patent Document 1), Japan. J. Appl. Phys., 11 (1972) 578-590 [M. Wakatsuki, K. Ichinose, T. Aoki] (Non-Patent Document 2), and Nature 259 (1976) 38 [S. Naka, K. Horii, Y. Takeda, T. Hanawa] (Non-Patent Document 3) disclose obtaining polycrystalline diamond by subjecting graphite as a starting material to direct conversion at an ultra high pressure of 14 to 18 GPa and an ultra high temperature of 3000 K or more.

Further, Japanese Patent Laying-Open No. 2002-066302. (Patent Document 1) describes a method of synthesizing fine diamond by heating carbon nanotube to 10 GPa or more and 1600° C. or more.

Furthermore, New Diamond and Frontier Carbon Technology, 14 (2004) 313 [T. Irifune, H. Sumiya] (Non-Patent Document 4) and SEI Technical Review 165 (2004) 68 [Sumiya, Irifune] (Non-Patent Document 5) disclose a method of obtaining dense and highly pure polycrystalline diamond by subjecting highly pure graphite as a starting material to direct conversion and sintering by indirect heating at an ultra high pressure of 12 GPa or more and an ultra high temperature of 2200° C. or more.
Patent Document 1: Japanese Patent Laying-Open No. 2002-066302
Non-Patent Document 1: J. Chem. Phys., 38 (1963) 631-643 [F. P. Bundy]
Non-Patent Document 2: Japan. J. Appl. Phys., 11 (1972) 578-590 [M. Wakatsuki, K. Ichinose, T. Aoki]
Non-Patent Document 3: Nature 259 (1976) 38 [S. Naka, K. Horii, Y. Takeda, T. Hanawa]
Non-Patent Document 4: New Diamond and Frontier Carbon Technology, 14 (2004) 313 [T. Irifune, H. Sumiya]
Non-Patent Document 5: SEI Technical Review 165 (2004) 68 [Sumiya, Irifune]

### DISCLOSURE OF THE INVENTION

### Problems to be Solved by the Invention

However, since the polycrystalline diamonds described in Non-Patent Documents 1 to 3 are all made by directly passing an electric current through electrically conductive non-diamond carbon such as graphite and heating the same, it is unavoidable that unconverted graphite remains. Further, the diamonds have grains varying in size and tend to be sintered partly insufficiently. Therefore, it has been possible to obtain only a polycrystalline body with insufficient mechanical properties such as hardness and strength and with a chipped shape, and it has been impossible to obtain a polycrystalline body capable of being used as a cutting tool.

Further, since the method disclosed in Patent Document 1 exerts pressure on carbon nanotube with a diamond anvil, and collects light and heats the carbon nanotube with a carbon dioxide gas laser, it is impossible to manufacture homogeneous polycrystalline diamond of a size applicable to cutting tools.

Furthermore, although the diamonds obtained by the methods disclosed in Non-Patent Documents 4 and 5 may have a very high hardness, they have insufficient reproducibility and unstable mechanical properties. Therefore, there has been a problem that, when they are used as cutting tools, their performances vary depending on samples.

The present invention has been made to solve the problems of the conventional techniques described above, and one object of the present invention is to provide a cutting tool having a high strength and a performance excellent in heat resistance when compared with polycrystalline diamond containing a binding agent that has been conventionally marketed, without causing problems such as uneven wear and cleavage cracks found in conventional monocrystalline diamond, by optimizing properties of polycrystalline diamond obtained by direct conversion and sintering to be applied to a cutting tool.

### Means for Solving the Problems

The inventors of the present invention have elaborately studied the relation between a microstructure of polycrystalline diamond obtained by direct conversion and mechanical properties and wear resistance property thereof to examine the causes of the above-mentioned problems. As a result, they have found that the polycrystalline diamond may have a composite construction in which a layered structure and a fine homogeneous structure are mixed, and the one having a composite construction in which these structures are distributed at an appropriate ratio is significantly hard and excellent in wear resistance. The inventors have also found that, in the conventional methods, the ratio between the layered structure and the fine homogeneous structure varies depending on the state of graphite serving as a starting material and minute differences in temperature rising time and pressure condition, and this is a cause of unstable mechanical properties and wear resistance property.

To solve the problems as described above, the inventors employed relatively coarse plate-like graphite or relatively coarse diamond with a non-graphite type carbon material or graphite with low crystallinity or fine-grained graphite added thereto, as a starting material, to the method of directly converting non-diamond carbon into diamond at an ultra high pressure and an ultra high temperature. As a result, they obtained polycrystalline diamond having a construction in which layered or relatively coarse diamond crystals were dispersed in a matrix of fine-grained diamond. The inventors have found that significantly hard and tough polycrystalline diamond can be obtained extremely stably by the effect of preventing plastic deformation and progression of fine cracks provided by the layered or coarse-grained diamond. The inventors have also found that, even in a case where graphite is used, a microstructure can be controlled by temperature rising time and pressure condition, and an appropriate construction as described above can be obtained.

It has been found that a cutting tool having high wear resistance and less uneven wear and cleavage cracks can be obtained by using this material and forming the same into a shape appropriate for a tool or a member, depending on the starting material and synthesis conditions. Therefore, the inventors have found that an extremely excellent cutting tool having durability twice or more that of a conventional material can be obtained by optimizing a starting material and thereby optimizing the microstructure of polycrystalline diamond, and conceived of the present invention.

Specifically, the present invention has a characteristic that there is provided a cutting tool having a cutting blade formed using polycrystalline diamond made substantially only of diamond and produced by directly converting a non-diamond type carbon material as a starting material into diamond and sintering the diamond at an ultra high pressure and an ultra high temperature without adding a sintering aid or a catalyst, the diamond having a mixed construction including fine-grained diamond with a maximum grain size of less than or equal to 100 nm and an average grain size of less than or equal to 50 nm and plate-like or particulate coarse-grained diamond with a minimum grain size of greater than or equal to 50 nm and a maximum grain size of less than or equal to 10000 nm. Further, the present invention has a characteristic that the polycrystalline diamond has a shape suitable for such a tool.

Preferably, the fine-grained diamond has a maximum grain size of less than or equal to 50 nm and an average grain size of less than or equal to 30 nm, and the coarse-grained diamond has a minimum grain size of greater than or equal to 50 nm and a maximum grain size of less than or equal to 1000 nm.

When the polycrystalline diamond is used in the cutting tool, it is preferable to provide roundness at a boundary portion between a rake face and a flank forming the cutting blade of the cutting tool. Preferably, the roundness has a radius of 100 to 2000 nm.

Further, it is effective when the cutting blade is a forming cutting blade. For example, when the cutting blade is a forming cutting blade having an arbitrary shape such as an arc, an ellipse, or a parabola, friction occurs between the cutting blade and a material being machined in various directions. Accordingly, in the case of monocrystalline diamond, the amount of wear significantly differs depending on the direction, and thus it is difficult to evenly wear the diamond, leading to a reduced life. In the case of a cutting tool using polycrystalline diamond of the present invention as a cutting blade, since the cutting tool can perform precision cutting and machining, it can perform precision machining that cannot be provided by conventional polycrystalline diamond, and its life is significantly increased when compared with a cutting tool using conventional polycrystalline diamond or monocrystalline diamond.

### EFFECTS OF THE INVENTION

Since the cutting tool of the present invention uses extremely hard and highly wear resistant polycrystalline diamond of single phase diamond obtained by direct conversion, it has a life twice or more that of a conventional cutting tool.

### BEST MODES FOR CARRYING OUT THE INVENTION

An appropriate amount of a non-graphite type carbon material is added to plate-like graphite or diamond with a grain size of 50 nm or more, to prepare a starting material. The starting material is directly converted into diamond and sintered under a pressure condition in which diamond is thermodynamically stable. As a result, polycrystalline diamond having a construction in which relatively coarse diamonds with an average grain size of, for example, 100 to 200 nm are dispersed in a matrix of significantly fine diamond with an average grain size of, for example, 10 to 20 nm is obtained. Since plastic deformation and progression of cracks are prevented at a relatively coarse diamond portion, the polycrystalline diamond exhibits an extremely tough and high hardness property, and property variations depending on samples are significantly reduced.

Preferably, the amount of the non-graphite type carbon material added to the plate-like graphite or diamond with a grain size of 50 nm or more is greater than or equal to 10% by volume and less than or equal to 95% by volume. If the added amount is less than 10% by volume, layered or coarse-grained diamonds are brought into contact with each other, stress is concentrated at an interface therebetween, and cracks and fractures are likely to occur, causing an unfavorable effect. If the added amount is greater than 95% by volume, the layered or coarse-grained diamond cannot sufficiently exhibit the effect of preventing plastic deformation and progression of fine cracks.

Examples of the non-graphite type carbon material described above include glassy carbon, amorphous carbon, fullerene, carbon nanotube, and the like. Fine carbon with a grain size of 50 nm or less prepared by mechanically pulverizing graphite using a planetary ball mill or the like can also be used.

The mixture described above is introduced into a capsule of a metal such as Mo. When pulverized fine carbon is used, it is necessary to perform the introducing operation within a highly pure inert gas. Next, the mixture introduced into the metal capsule is held for a prescribed period of time at a temperature of 1500° C. or more and at a pressure under which diamond is thermodynamically stable, using an ultra high pressure and ultra high temperature generation apparatus capable of performing isotropic pressurization or hydrostatic pressurization such as a multi-anvil type ultra high pressure apparatus or a belt type ultra high pressure apparatus. The non-graphite type carbon is directly converted into diamond and simultaneously sintered. In a case where plate-like graphite with a grain size of 50 nm is used, it is necessary to treat the graphite at a high temperature of 2000° C. or more in order to completely convert the graphite into diamond.

Consequently, polycrystalline diamond having a construction in which layered or relatively coarse diamond crystals are dispersed in a matrix of fine-grained diamond can be stably obtained. Further, polycrystalline diamond having a similar construction can be obtained by performing the high pressure and high temperature treatment described above on graphite as a starting material, at a heating rate of 100 to 1000° C./minute. Since the layered or coarse-grained diamond exhibits the effect of preventing plastic deformation and progression of fine cracks, the polycrystalline body has an extremely high hardness of 120 GPa or more, and thus is significantly excellent in wear resistance and has less property variations.

The polycrystalline diamond is used and bonded to a tool body of a cutting tool, roughly shaped by a laser or the like, and a surface of the polycrystalline diamond is polished. The polished surface has a surface roughness Ra of 0.1 μm or less. When such a surface roughness is employed in a cutting tool, the effects of suppressing adhesion or the like of a workpiece, achieving continuous stable cutting, and stabilizing life can be obtained.

Preferably, roundness is provided at a boundary portion between a rake face and a flank forming a cutting blade, and the roundness has a radius of 100 to 2000 nm.

By providing roundness to a cutting blade of the polycrystalline diamond of the present invention as described above, an unstably worn area resulting from a difference in crystal orientation of diamond particles arranged linearly in an initial cutting blade is eliminated, and the cutting blade can be used from a stably worn area. Thereby, the cutting blade has less irregularities, and thus the effect of improving a roughness of a machined surface can be obtained.

This cutting tool is suitable for precisely cutting and machining an aluminum alloy, a copper alloy, electroless nickel plating, resin, hard and brittle materials and difficult-to-machine materials such as glass, carbon, MMCs (Metal Matrix Composites), and the like.

### EXAMPLES

Graphite powder good in crystallinity with a grain size of 0.05 to 10 μm and a purity of 99.95% or more, or synthetic diamond powder with a grain size of 0.05 to 3 μm, with ultra-finely pulverized graphite powder or a variety of non-graphite type carbon materials such as glassy carbon powder, C60 powder, and carbon nanotube powder added thereto, was introduced into an Mo capsule and sealed, and treated under various pressure and temperature conditions for 30 minutes using an ultra high pressure generation apparatus. The generated phase of an obtained sample was identified by X-ray diffraction, and the grain size of a constituent particle was examined by TEM observation. Further, the surface of the obtained sample was mirror polished, and the hardness at the polished surface was measured with a micro Knoop hardness meter.

Table 1 shows experimental results.

TABLE 1

| | Starting Material | | | | | Product (Polycrystalline Diamond) | | | | |
|---|---|---|---|---|---|---|---|---|---|---|
| | | | | Added | Synthesis Conditions | Grain Size of | | Grain Size of | Knoop | |
| | Base Material | | Additive | Amount | Pressure, Temperature | Coarse-Grained Portion | | Fine Grains | Hardness | |
| Example 1 | 1-3 | μm Gr | 35 nm Gr | 50 vol % | 12 GPa, 2300° C. | 50-300 | nm (layered) | 40 nm | 120 | GPa |
| Example 2 | 1-3 | μm Gr | 25 nm Gr | 70 vol % | 12 GPa, 2300° C. | 50-300 | nm (layered) | 30 nm | 130 | GPa |
| Example 3 | 1-3 | μm Gr | 10 nm Gr | 30 vol % | 12 GPa, 2100° C. | 50-200 | nm (layered) | 15 nm | 130 | GPa |
| Example 4 | 0.1-1 | μm Dia | 10 nm Gr | 50 vol % | 9 GPa, 1900° C. | 100-1000 | nm | 15 nm | 120 | GPa |
| Example 5 | 1-3 | μm Gr | Glassy Carbon | 50 vol % | 9 GPa, 1900° C. | 50-200 | nm (layered) | 10 nm | 120 | GPa |
| Example 6 | 1-3 | μm Gr | C60 | 50 vol % | 9 GPa, 1900° C. | 50-200 | nm (layered) | 10 nm | 120 | GPa |
| Example 7 | 1-3 | μm Gr | Carbon Nanotube | 50 vol % | 9 GPa, 1900° C. | 50-200 | nm (layered) | 10 nm | 120 | GPa |
| Example 8 | 0.1-1 | μm Dia | Glassy Carbon | 50 vol % | 9 GPa, 1900° C. | 100-1000 | nm | 10 nm | 120 | GPa |
| Example 9 | 0.1-1 | μm Dia | C60 | 50 vol % | 9 GPa, 1900° C. | 100-1000 | nm | 10 nm | 120 | GPa |
| Example 10 | 0.1-1 | μm Dia | Carbon Nanotube | 50 vol % | 9 GPa, 1900° C. | 100-1000 | nm | 10 nm | 120 | GPa |
| Comparative | 1-3 | μm Gr | None | — | 12 GPa, 2300° C. | 50-100 | nm (layered) | 25 nm | 100-130 | GPa |
| Example 1 | | | | | | | | | | |
| Comparative | 0.1-1 | μm Dia | None | — | 12 GPa, 2300° C. | 100-1000 | nm | None | 70-90 | GPa |
| Example 2 | | | | | | | | | | |

| | | | | | | | | |
|---|---|---|---|---|---|---|---|---|
| Comparative | Glassy Carbon | None | — | 9 GPa, 1900° C. | None | 10 nm | 95 | GPa |
| Example 3 | | | | | | | | |
| Comparative | C60 | None | — | 9 GPa, 1900° C. | None | 10 nm | 80 | GPa |
| Example 4 | | | | | | | | |

The above results show that, when graphite or diamond with an average grain size of 50 nm or more, with finely pulverized graphite or a non-graphite type carbon material added thereto in a range of greater than or equal to 10% by volume and less than or equal to 95% by volume, is prepared as a starting material, and subjected to direct conversion and sintering at an ultra high pressure and an ultra high temperature, polycrystalline diamond having a construction in which layered diamond or relatively coarse diamond crystals with a grain size of 50 nm or more are dispersed in a matrix of fine-grained diamond with an average grain size of 50 nm or less is stably obtained. It is found that the obtained polycrystalline body has a hardness extremely higher than that of a sintered body of a conventional Co binder (60 to 80 GPa), and has no variations in hardness properties as seen in a polycrystalline body using graphite as a starting material. Based on these results, it is considered that when the polycrystalline diamonds of Examples 1 to 10 are applied to a cutting tool or a wear resistant member, life is significantly improved.

Accordingly, cutting tools were fabricated using the polycrystalline diamond obtained in Example 1 (the present tools A to E, F, G), and a cutting test was performed. For comparison, a cutting tool using conventional monocrystalline diamond (comparative tool A) and a tool using sintered diamond containing a conventional Co binder (comparative tool B) were also fabricated. Tool shapes, a workpiece, and cutting conditions were as follows:

### Test Example 1

### (1) Tools

(Common Specifications)
corner radius 0.8 mm, relief angle 7°, rake angle 0°

(Specifications for Individual Tools)
the present tool A: cutting blade roundness a radius of 100 nm
the present tool B: cutting blade roundness a radius of 1000 nm
the present tool C: cutting blade roundness a radius of 2000 nm
the present tool D: cutting blade roundness a radius of 50 nm
the present tool E: cutting blade roundness a radius of 3000 nm

### (2) Workpiece

aluminum alloy AC4B φ150×190 mm

### (3) Machining Method

cylinder periphery turning wet cutting (2% aqueous emulsion)

### (4) Cutting Conditions

number of revolutions of a main spindle: 1,700 rpm (constant number of revolutions)

feed speed: 0.1 mm/rev

depth: φ0.2 mm/diameter

cutting distance: 30 km

As a result of performing a cutting test under the conditions described above, the following were found:

1) To compare tool lives of the present tools A to E and comparative tool A after cutting for 30 km, the amount of wear of a flank was confirmed. The present tools A and D had a flank wear of 6 μm, the present tool B had a flank wear of 6.5 μm, and the present tool C had a flank wear of 7 μm, whereas comparative tool A (a monocrystalline diamond cutting tool) had a flank wear of 7.5 μm, indicating an increase of 7 to 25%. Accordingly, the present tools A to D had more excellent lives. The present tool E had a flank wear of 8 μm, which was greater than that of comparative tool A.

2) When the surface roughnesses of the present tools A to C were compared with the surface roughness of comparative tool A, both were 1.5 μm, and tool marks had the same sectional shape. The roughnesses of machined surfaces machined by the present tools A to C were equal to that machined by comparative tool A as a monocrystalline diamond cutting tool.

3) On the other hand, in the present tool D, fine cracks of about 200 to 500 nm occurred in its cutting blade, and irregularities of the cutting blade caused by the cracks were transferred in a tool mark on a machined surface. Therefore, the machined surface had a quality level worse than those obtained by using the present tool A and comparative tool A.

4) Further, in the case of using the present tool E, slight chatter marks were observed in a tool mark.

### Test Example 2

Another cutting test was performed under the following conditions:

### (1) Tools

(Common Specifications)
corner radius 0.8 mm, relief angle 7°, rake angle 0°

(Specifications for Individual Tools)
the present tool F: cutting blade roundness a radius of 500 nm
comparative tool B: cutting blade roundness a radius of 500 nm

### (2) Workpiece

aluminum alloy AC4B, φ150 mm×190 mm with four grooves spaced apart

### (3) Machining Method

cylinder periphery turning wet cutting (2% aqueous emulsion)

### (4) Cutting Conditions

number of revolutions of a main spindle: 1,700 rpm (constant number of revolutions)

feed speed: 0.04 mm/rev

depth: φ0.1 mm/diameter

cutting distance: 10 km

As a result of performing a cutting test under the conditions described above, the following were found:

1) To compare tool lives of the present tool F and comparative tool B after cutting for 10 km, the amount of wear of a flank was confirmed. The present tool F had a flank wear of 1.0 μm, whereas comparative tool B (a sintered diamond cutting tool) had a flank wear of 3.5 μm, indicating an increase of 3.5 times. Accordingly, the present tool F had a more excellent life.

2) Further, when the cutting resistance (radial force/thrust force) of the present tool F was compared with that of comparative tool B, the present tool F had a cutting resistance of 0.8 N, whereas comparative tool B had a double cutting resistance of 1.6 N. Accordingly, it was confirmed that the present tool had cutting quality better than that of a conventional sintered diamond cutting tool.

### Test Example 3

The polycrystalline diamond obtained in Example 1 was used to fabricate the present tool G as a forming cutting tool with a concavely rounded cutting blade having the following specifications. For comparison, cutting tool B using monocrystalline diamond was also fabricated. The tools were fabricated as described below. Firstly, roughly formed diamond was brazed on a base metal. Thereafter, a flank was pressed against the outer periphery of a copper disk machined to have a convexly rounded shape with diamond fine particles applied thereto, and polishing was performed by causing the flank and the outer periphery to rub against each other. Consequently, a concavely rounded shape was transferred onto the flank of the diamond. On this occasion, the flank of the present tool G was uniformly polished over an entire surface, whereas the flank of comparative tool B had a portion having a rough and nonuniform polished surface resulting from crystal anisotropy at a position in an arc of about 5° to 10° from the center of roundness to both sides.

### (1) Tool Specifications

relief angle: 7°
rake angle: 0°
shape of the cutting blade: concavely rounded with a radius of 2 mm, arc area 30°
cutting tool's blade height: 10 mm, total length 100 mm, width 10 mm

The above results show that, since the tool of the present invention does not have crystal anisotropy as seen in a conventional monocrystalline diamond cutting tool, uniform machining is readily provided, and there is no need to set crystal orientation using an X ray and perform highly precise positioning brazing for determining a direction at the time of fabrication. Therefore, processes and time required for fabricating the tool can be significantly reduced.

### Test Example 4

The present tool G obtained in test example 3 was used, and for comparison, comparative tool A using monocrystalline diamond was fabricated. Carbon was machined using these tools.

### (1) Tools

(Tool Specifications)
corner radius 0.8 mm, relief angle 7°, rake angle 0°
cutting blade roundness a radius of 500 nm

### (2) Workpiece

carbon φ50 mm×30 mm with 12 grooves spaced apart

### (3) Machining Method

cylinder periphery turning dry cutting

### (4) Cutting Conditions

number of revolutions of a main spindle: 2,000 rpm (constant number of revolutions)

feed speed: 0.1 mm/rev

depth: φ0.2 mm/diameter

number of machined units: 20 units

As a result of performing a cutting test under the conditions described above, a large crack of 20 which seemed to be crystal cleavage, occurred in the monocrystalline diamond cutting tool as comparative tool A, whereas only a crack of about 1 μm occurred and a surface roughness of less than or equal to 3.2 S, which was a prescribed value, was obtained in the present tool G.

As is obvious from the test results described above, when compared with a tool using a conventional material, the cutting tool of the present invention is excellent in wear resistance, defect resistance, cutting quality (cutting resistance), and the surface roughness of a workpiece after cutting, and can be readily fabricated.

1. A cutting tool having a cutting blade formed of polycrystalline diamond made substantially only of diamond and produced by directly converting a non-diamond type carbon material as a starting material into diamond and sintering the diamond at an ultra high pressure and an ultra high temperature without adding a sintering aid or a catalyst, said polycrystalline diamond having a mixed construction including fine-grained diamond with a maximum grain size of less than or equal to 100 nm and an average grain size of less than or equal to 50 nm and plate-like or particulate coarse-grained diamond with a minimum grain size of greater than or equal to 50 nm and a maximum grain size of less than or equal to 10000 nm.

2. The cutting tool according to claim 1, wherein said fine-grained diamond has a maximum grain size of less than or equal to 50 nm and an average grain size of less than or equal to 30 nm.

3. The cutting tool according to claim 1, wherein said coarse-grained diamond has a minimum grain size of greater than or equal to 50 nm and a maximum grain size of less than or equal to 1000 nm.

4. The cutting tool according to claim 1, wherein roundness is provided at a boundary portion between a rake face and a flank forming said cutting blade.

5. The cutting tool according to claim 4, wherein said roundness has a radius of 100 to 2000 nm.

6. The cutting tool according to claim 1, wherein said cutting blade is a forming cutting blade.
